(19) United States
(12) Patent Application Publication
(10) Pub. No.: US 2005/0048267 A1
(43) Pub. Date: Mar. 3, 2005

(54) Optical element, optical element wafer, and manufacturing methods for the same

(76) Inventors: Akira Tezuka, Shizuoka-shi (JP); Fuminori Aikawa, Shizuoka-shi (JP); Masayuki Tsuchida, Shizuoka-shi (JP); Fumiki Komagata, Shimada-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/443,082

(22) Filed: May 22, 2003

(30) Foreign Application Priority Data
May 28, 2002 (JP) P2002-154013
May 1, 2003 (JP) P2003-126337

(51) Int. Cl. B32B 3/00

(52) U.S. Cl. 428/195.1

(57) ABSTRACT

The present invention provides an optical element, an optical element wafer and a method of manufacturing the same. The optical element comprises a optical film adhered on an substrate of the optical element. The method for manufacturing the optical element wafer comprising the steps of dividing a base material of a optical film into a plurality of optical films, separating the optical film base material by removing sections where no optical film is to be formed, adhering the divided optical films on the substrate base material, and a plurality of optical elements are obtained by dividing the substrate base material with the optical film adhered on one surface of the individual substrate.

### BACKGROUND OF THE INVENTION

1. Field of the Invention

This invention relates to an optical element, which is joined to a main body of a package for accommodating electrical component elements, an optical element wafer, which is capable of manufacturing, storing, and carrying a plurality of the optical elements in a single operation, and manufacturing methods of the optical element and the optical wafer.

2. Description of Related Art

Conventionally, various electronic component elements are accommodated in a box-like main body of a package having an opening, and a lid for sealing electronic components (hereinafter sometimes abbreviated as “lid”) is then joined to the end of the open side of the main body of a package; the electronic component elements are accommodated in the package comprising the main body of a package and the lid, and a variety of electronic components are manufactured. The electronic components are, for example, used as devices for optical pickup, and the like.

For example, there has recently been proposed a device for optical pickup in which a phase difference film comprising an optical film has been pasted to the lid of the package. According to this device, the phase difference film converts laser light to elliptical polarized light, achieving greater precision ((as shown in Japanese Patent Application, First Publication No. 2001-249226).

In contrast, the present inventors proposed in Japanese Patent Application, First Publication No. 2002-270708 a lid wafer which can manufacture, store, and convey a plurality of lids in a single operation, and applied this in an optical element comprising a lid fitted with an optical film. As shown in FIGS. 9A to 9C, a conventional method for manufacturing the lid wafer (optical element wafer) comprising the lid fitted with an optical film (optical element) will be explained. FIGS. 9A to 9C are cross-sectional views of the structure of the optical element wafer during manufacture.

Firstly, as shown in FIG. 9A, an optical film base material 130 for obtaining a plurality of optical films is pasted to one side of a lid base material 110, comprising a base material of glass, with an adhesive layer 120 therebetween (Process No. 1).

A holding film 140 comprises a resin film with an adhesive layer 150 on one side is prepared, and the periphery of the holding film 140 is pasted to an wafer ring with the adhesive layer 150 therebetween (Process No. 2). Then, as shown in FIG. 9B, the layered structure made in Step 1 is pasted over a region of the holding layer 140 which is inside the wafer ring, with the adhesive layer 150 therebetween (Process No. 3).

Finally, as shown in FIG. 9C, the lid base material 110 and the substrate base material 130 are cut simultaneously by using a blade, dividing the lid base material 110 into a plurality of lids 111 forming the base material, and dividing the substrate base material 130 into a plurality of optical films 131, thereby obtaining an optical element wafer 200 wherein the plurality of optical elements 100 comprising the lids fitted with optical film have been produced in a single operation (Process No. 4).

However, conventional optical elements and optical element wafers have problems such as the following.

In devices for optical pickup and the like, although light passes only through the center and sections near the center, the expensive optical film is conventionally pasted over the entire surface of the lid comprising the base material; this increases the cost of the optical elements.

The optical element is attached to the package main body by pressing the four corners of its optical film side with pins, but this pressing force may cause the optical film on the outer side of the pins to peel away and rise up.

Furthermore, in manufacturing the optical element wafer, as described in Step 4, the lid base material (substrate base material) and the substrate base material, which are comprised of different materials, must be cut simultaneously. The appropriate cutting speed for the resin optical film base material is slower than that of the glass lid base material. For this reason, in cutting the lid base material, the cutting speed must be set slower so as to match that of the substrate base material, resulting in poor product performance. The cutting depth is controlled by computer, with due consideration to the amount of abrasion of the blade, to avoid cutting as far as the holding layer; however, the amount of abrasion of the blade varies when simultaneously cutting the lid base material and the substrate base material, since they are comprised of different materials, and it may become impossible to control the depth of the cut.

Moreover, in manufacturing the optical element wafer, when the lid base material having a large surface area and the substrate base material are pasted together, air is sometimes trapped between the lid (substrate material) and the optical film.

Consequently, in heat cycle tests carried out after the electronic component has been manufactured, there is a danger that the air between the lid and the optical film will expand, causing the optical film to peel away from the lid.

### SUMMARY OF THE INVENTION

Accordingly, this invention has been realized in consideration of the problems mentioned above, and aims to provide an optical element which is inexpensive, and prevents the optical film from partially peeling away and rising up at the time of pasting it to the main body of a package; an optical element wafer which can manufacture, store, and carry a plurality of the optical elements in a single operation; and manufacturing methods thereof.

Furthermore, the method for manufacturing the optical element wafer of this invention shortens the cutting process of the substrate base material, and, in addition, stably controls the cutting depth of the substrate base material and the substrate base material, enabling them to be evenly affixed together.

The present inventors have considered the problems mentioned above, and have invented the optical element, the optical element wafer, and methods for manufacturing the same, as described below.

The optical element of this invention comprises an optical film, which is partially pasted to a substrate.

The optical element wafer of this invention comprises a substrate base material, and a holding material, which is pasted to one face of the substrate base material. The substrate base material is divided into a plurality of substrates, and an optical film is partially pasted to each substrate.

A first method for manufacturing the optical element according to this invention comprises the steps of dividing an optical film base material into a plurality of optical films; removing sections of the substrate base material where the optical film is unnecessary; dividing a substrate base material into a plurality of substrates; pasting together the optical films and the substrates, thereby obtaining a plurality of optical elements; and extracting the optical elements.

A second method for manufacturing the optical element according to this invention comprises the steps of: dividing an optical film base material into a plurality of optical films; removing sections of the substrate base material where the optical film is unnecessary; pasting the optical films to a substrate base material; dividing the substrate base material into a plurality of substrates, thereby obtaining a plurality of optical elements; and extracting the optical elements.

Furthermore, the first method for manufacturing the optical element wafer according to this invention comprises the steps of dividing an optical film base material into a plurality of optical films; removing sections of the substrate base material where the optical film is unnecessary; dividing a substrate base material into a plurality of substrates; and pasting together the optical films and the substrates.

Another embodiment of the first method for manufacturing the optical element wafer according to this invention comprises the steps of pasting an optical film base material onto a first holding material; dividing the substrate base material into a plurality of optical films; peeling away sections of the optical film base material and sections of the first holding material where the optical film is unnecessary from the first holding material; pasting a substrate base material onto a second holding material; dividing the substrate base material into a plurality of substrates; and pasting together the optical films on the first holding material and the substrates on the second holding material.

Still another specific aspect of the first method for manufacturing the optical element wafer according to this invention comprises the steps of pasting an optical film base material onto a first holding material; dividing the substrate base material into a plurality of optical films; pasting a second holding material onto the side of the substrate base material which is opposite to the first holding material; peeling away from the first holding material sections of the substrate base material and the first holding material where the optical film is unnecessary from the second holding material; pasting a substrate base material onto a third holding material; dividing the substrate base material into a plurality of substrates; and pasting together the optical films on the second holding material and the substrates on the third holding material.

Another second method for manufacturing the optical element wafer according to this invention comprises the steps of dividing an optical film base material into a plurality of optical films; removing sections of the optical film base material where the optical films is unnecessary; pasting the optical films to a substrate base material; and dividing the substrate base material into a plurality of substrates, thereby obtaining a plurality of optical elements.

In the method for manufacturing the optical element wafer, the step of dividing the substrate base material into a plurality of optical films comprises a step of rapping the optical film base material by using a rapping mold formed for dividing the optical film into a required pattern in patterning the optical film base material.

### BRIEF DESCRIPTION OF THE DRAWINGS

FIGS. 1A to 1G are diagrams showing examples of specific constitutions of an optical element according to this invention.

FIG. 2 is a diagram showing one example of a constitution of an optical pickup device comprising the optical element of this invention.

FIG. 3 is a diagram showing another example of a constitution of an optical pickup device comprising the optical element of this invention.

FIG. 4 is a diagram showing the constitution of a solid sate imaging device comprising the optical element of this invention.

FIGS. 5A and 5B are diagrams showing the constitution of an optical element wafer according to one embodiment of the present invention.

FIGS. 6A to 6E are process diagrams showing another manufacturing method of the optical element wafer according to one embodiment of this invention.

FIGS. 7A and 7B are step diagrams showing a manufacturing method of the optical element wafer according to an embodiment of this invention.

FIGS. 8A to 8D are process diagrams showing a manufacturing method of the optical element wafer according to one embodiment of this invention.

FIGS. 9A to 9C are step diagrams showing a manufacturing method of a conventional optical element wafer.

### DESCRIPTION OF THE PREFERRED EMBODIMENTS

Hereinafter, the present invention will be explained in detail.

Optical Element

The optical element of this invention comprises an optical film pasted to a substrate, and is characterized in that the optical film is provided partially.

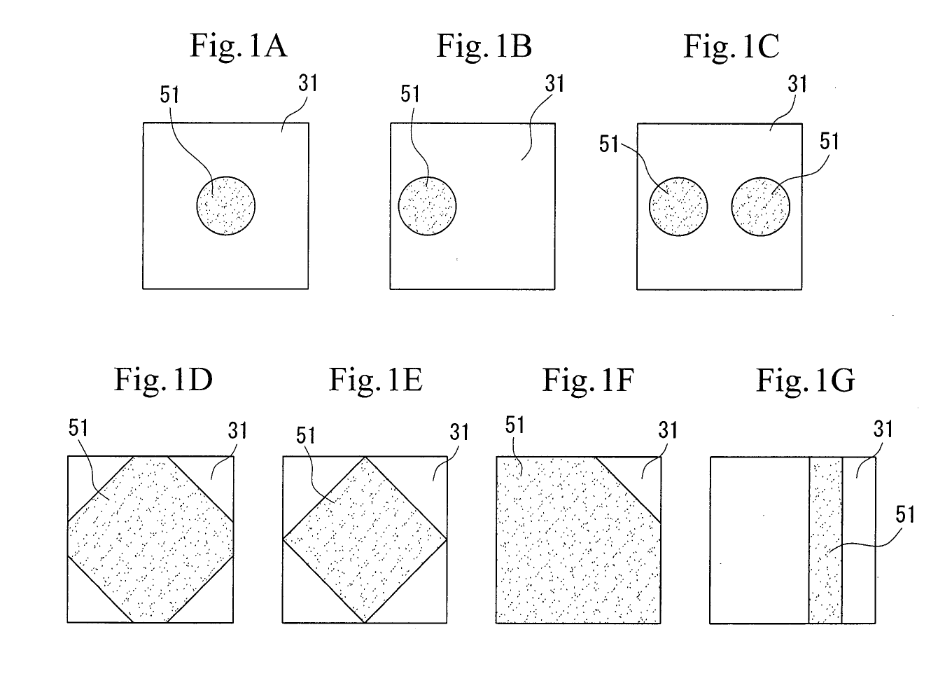

FIG. 1A shows an example of a specific constitution of the optical element of this invention, in which a circular optical film 51 is pasted approximately in the center of a substrate 31, which is square in plan view, the area of the optical film 51 being smaller than that of the substrate 31. The optical film 51 may be pasted in a position other than the center of the substrate 31, such as at one side of the substrate 31, as shown in FIG. 1B. Alternatively, a plurality of optical films 51 may be provided, as shown in FIG. 1C.

As examples of other possible constitutions, FIGS. 1D and 1E show constitutions where the optical film 51 is provided so as to avoid the four corners of the substrate 31, FIG. 1F shows a constitution where the optical film 51 is pasted over all but one corner, and FIG. 1G shows a constitution where a strip-like optical film 51 is pasted over the substrate 31.

Incidentally, the shape and size of the optical film 51 is not restricted to those shown in these diagrams, and may be designed as appropriate. Similarly, the substrate 31 need not necessarily be square, and may be circular, triangular, and the like, as is appropriate to the shape of the opening in the main body of a package.

According to the optical element of this invention, an expensive optical film is pasted partially, thereby reducing the cost.

In the optical element of this invention, at the time of manufacturing the electronic components, the sections where the optical film is unnecessary are pressed by pins, enabling it to be attached to the main body of a package without a pressing force being applied to the optical film itself. Consequently, at the time of attaching the optical film to the main body of a package, there is no danger that the optical film will peel away and rise up. In particular, as shown in FIGS. 1A, 1D, and 1E, when attaching the optical film to the main body of a package by pressing the pins at the four corners, the optical film should preferably not be pasted at the four corners of the substrate.

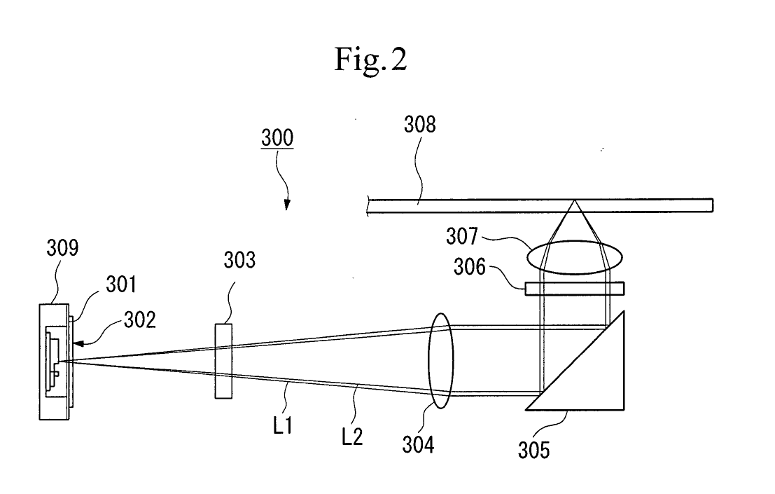

The optical element of this type can be, for example, built in a laser light emitting and receiving elements including laser light sources (such as a laser emitting diode) and/or laser light detectors (such as a laser light receiver). FIG. 2 is a schematic diagram showing the constitution of an optical pickup device for optical disk, which comprises a laser light emitting and receiving elements provided with the optical element of the present invention attached thereto. The optical pickup device for optical disk 300 comprises a laser light emitting and receiving elements 302 having an optical element 301 attached thereto, an astigmatic correcting plate 303, a collimetor 304, a mirror 305, an opening-restricted aperture 306, and a bifocal object lens 307. In the optical pickup device for optical disk 300, laser lights L1 and L2 from the laser light emitting and receiving elements 302 pass via the astigmatic correcting plate 303, the collimetor 304, the mirror 305, the opening-restricted aperture 306, and the bifocal object lens 307, and radiate onto an optical disk 308. In addition, light is reflected from the optical disk 308, and is returned to the laser light emitting and receiving elements 302 along the same path as the radiated light. An optical element 301 is connected to the laser light emitting and receiving elements 302 so as to seal the opening in a main body of a package 309, and functions as a quarter wavelength plate. There are no restrictions on the manner in which the optical element 301 is connected. In other words, it may be connected so as to seal the main body of a package 309 in an airtight state, or to seal it with the opening of the main body of a package 309 still partially open.

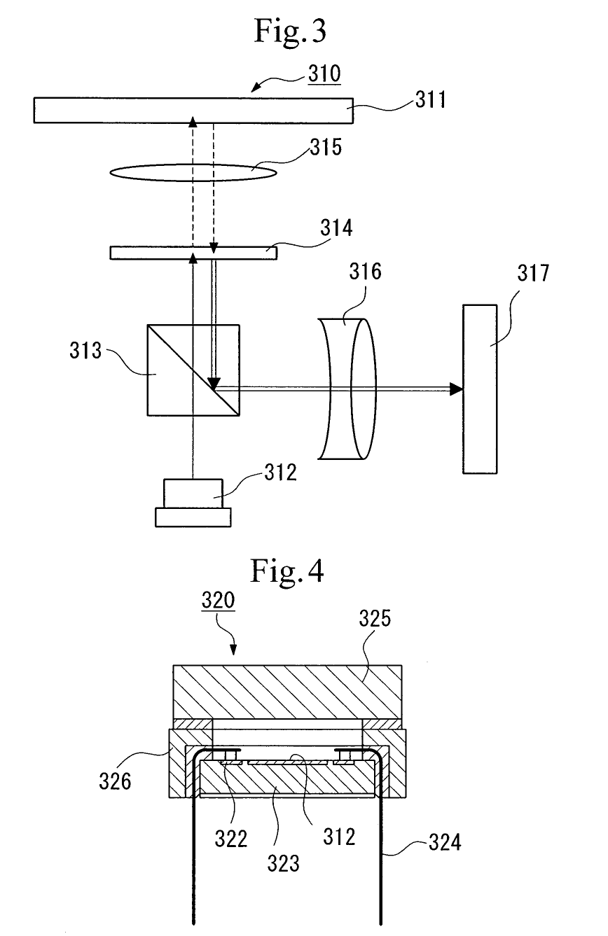

The optical element may be incorporated into the optical pickup device instead of being connected to the main body of a package. FIG. 3 is a diagram schematically showing an optical pickup device comprising an optical element, which is not connected to the main body of a package. The optical pickup device 310 comprises a laser light source 312 for reading an optical disk 311, a polarized beam splitter 313, an optical element 314, an object lens 315, an image-forming lens 316, and a laser light detector 317. The optical element 314 converts light radiated from one direction from linear polarized light to circular polarized light, and converts light radiated from another direction from circular polarized light to linear polarized light while rotating its declination by 90 degrees.

In the optical pickup device 310 of this type, laser light from the laser light source 312 passes through the polarized beam splitter 313 and, when passing through the optical element 314, is converted from linear polarized light to circular polarized light. Light reflected from the optical disk 311 (circular polarized light) passes once again through the optical element 314, and is converted from circular polarized light to linear polarized light at a declination of 90 degrees to that of the first linear polarized light. The polarized beam splitter 313 allows the first linear polarized light to pass, but reflects the linear polarized light at a declination of 90 degrees. In this way, the light which is radiated and reflected to/from the optical disk 311 is split.

The optical element can be used as an optical filter (e.g. a lowpass filter, an infrared cut filter, and such like) in a CCD (charge coupled device) mounted in a video or digital camera or a fixed-photograph device. FIG. 4 is a schematic diagram of the constitution of a fixed-photograph device comprising an optical element. The fixed-photograph device 320 comprises a fixed-photograph element 323 having a light-receiving face 321 in its center and an electrode pad 322 extending from the light-receiving face 321 on both sides, a lead wire 324, the tip of which is connected to the electrode pad 322, and an optical element 325, which is secured to the fixed-photograph element 323 on the opposite side from the light-receiving face 321. A container 326 has a frame-like shape so as to contain the fixed-photograph element 323 with the light-receiving face 321 facing toward the outside, and is inserted between the fixed-photograph element 323 and the optical element 325 so that it connects with their opposing faces on each side. An optical element capable of functioning as, for example, an infrared cut filter or a crystal cut filter, is used as the optical element 325 of the fixed-photograph device 320.

Optical Element Wafer

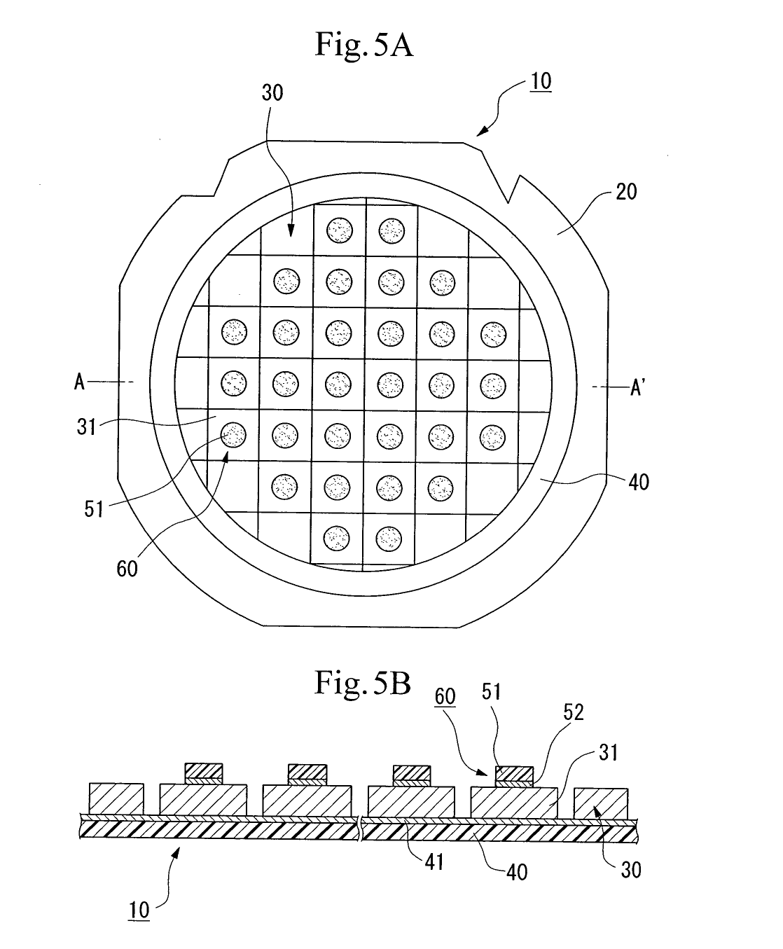

Subsequently, the constitution of the optical element wafer according to an embodiment of this invention will be explained based on FIGS. 5A and 5B.

FIG. 5A is a plan view of the optical element wafer of this embodiment as seen from the op film side, and FIG. 5B is a cross-sectional view taken along the line A-A′ of the optical element wafer shown in FIG. 5A. Each of the members and layers in these diagrams is shown in a different reduced scale in order to make them easily distinguishable.

As shown in FIGS. 5A and 5B, the optical element wafer 10 of this embodiment mainly comprises a ring-shaped wafer ring 20, a disk-shaped substrate base material 30 of glass, quartz, crystal, silicon, ceramic, resin, or the like, and a disk-shaped holding material 40 which holds the substrate base material 30 and is comprised of resin film, such as polyolefin film.

More specifically, an adhesive layer 41 is provided over the entire top face of the holding material 40, and a the peripheral edge of the holding material 40 is pasted to the bottom face of the wafer ring 20. The substrates 31 is pasted over the region inside the wafer ring 20 on top of the holding material 40, with the adhesive layer 41 therebetween.

The substrate base material 30 is cut so that its shape is grid-like in plan view, and is divided into a plurality of square substrates 31, arranged in a matrix-like formation. The substrate base material 30 is cut by a conventional dicing technique used in the manufacture of semiconductors and the like, so that the gaps between the substrates 31 are extremely narrow. The pattern and individual shapes of the substrates 31 are not limited to those shown in FIGS. 5A and 5B. Multiple types of substrates 31 of different shapes and sizes may be provided. When it is possible to individually remove the substrates 31 from the optical element wafer 10, it is not necessary to completely cut adjoining substrates 31 in both their plan and cross-sectional directions.

Disk-shaped optical films 51 are partially pasted over the faces of the substrates 31 on the opposite side to the holding material 40, excluding the peripheral edges of the substrates 31, so that the optical element wafer 10 comprises a plurality of optical elements 60.

When necessary, an adhesive layer may be provided on the faces of the substrates 31 on the side of the optical films 51, or the faces on the side of the holding material 40, in the sections which connect to the main body of a package. This constitution is preferable since it enables the optical elements 60 to be connected to the main body of a package with the adhesive layer therebetween, thereby simplifying the manufacturing processes of the electronic components.

When necessary, in the optical element wafer 10, an unillustrated protective material comprising a resin film or the like may be provided on the top face of the wafer ring 20, so that the optical elements 60 are held on each side by the holding material 40 and the protective material. This constitution is ideal in preventing damage to the substrates 31 when storing and carrying the optical element wafer 10 after it has been manufactured, and in preventing impurities in the atmosphere from sticking to the substrates 31.

According to the optical element wafer 10 having the constitution described above, a plurality of the optical elements 60 of this invention can be manufactured, stored, and carried, in a single operation.

Manufacturing Method of the Optical Element Wafer

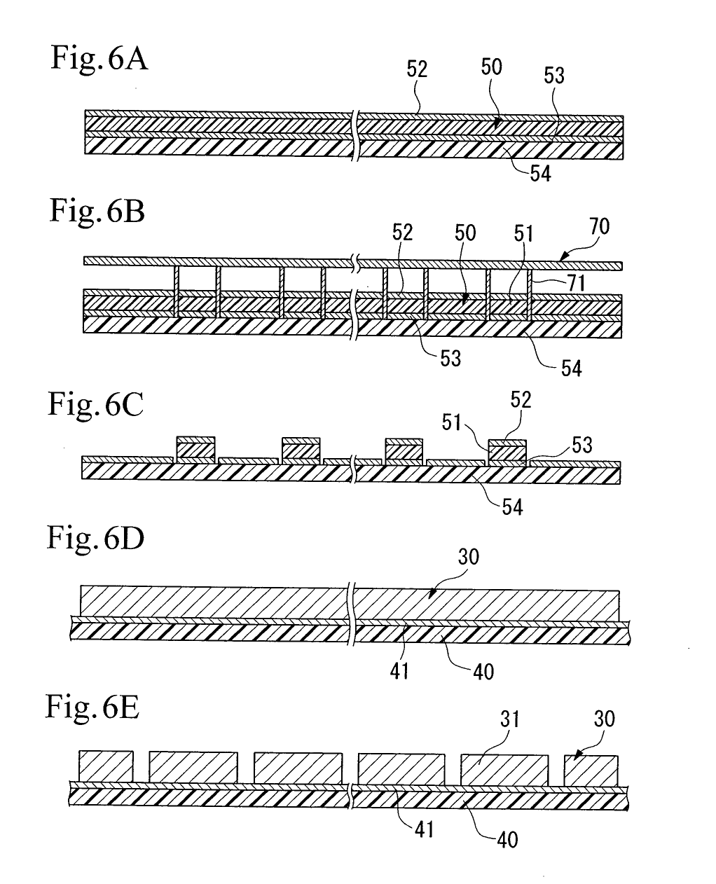

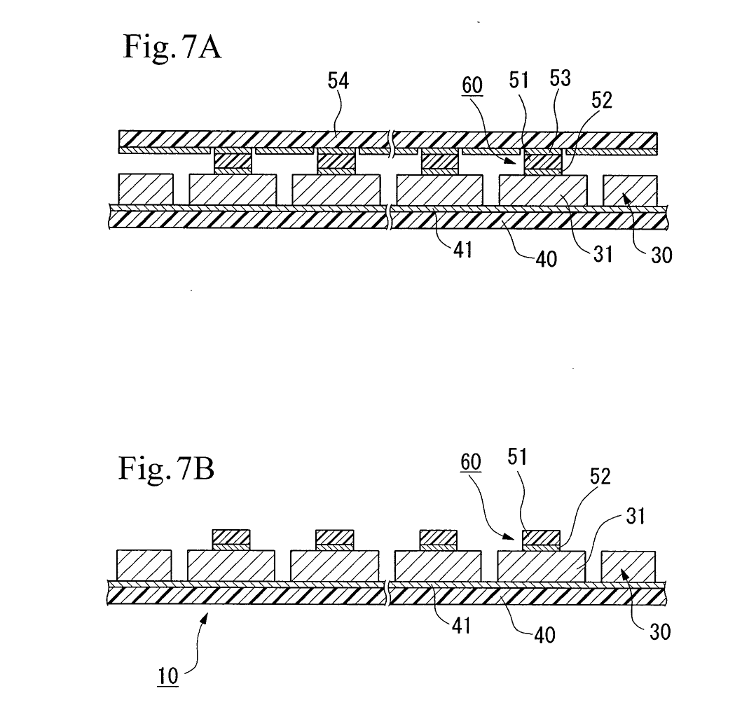

Subsequently, one example of a manufacturing method of the optical element wafer described above will be explained based on FIGS. 6A to 6D and FIGS. 7A and 7B. FIGS. 6A to 6D and FIGS. 7A and 7B are cross-sectional views of the structure of an optical element wafer during manufacture.

Firstly, as shown in FIG. 6A, a holding material 54 comprising a resin film such as polyethylene terephthalate is pasted over one face of a disk-shaped optical film base material 50, which a plurality of optical films are obtained from, with an adhesive layer 53 therebetween, and another adhesive layer 52 is provided on the other face (Step 1). In this example, the substrate base material 50 and the substrate base material 30 have the same shape in plan view, but their shapes and sizes may be designed as appropriate.

Next, as shown in FIG. 6B, the substrate base material 50 is rapped using a rapping mold 70 comprising a plurality of cylindrical protrusions 71 having diameters equal to the outer diameters of the optical films 51, dividing the substrate base material 50 into a plurality of optical films 51 (Step 2). At this time, the rapping mold 70 is pressed from the adhesive layer 52 side and cuts at least the adhesive layer 52 and the substrate base material 50, while leaving the entire holding material 54 uncut. Since the substrate base material 50 must be completely cut in the up-down direction, the cut should preferably reach part of the adhesive layer 53 and the holding material 54 underneath the substrate base material 50. FIG. 6B shows an example where the cut extends to the adhesive layer 53.

The shape, material, and the size of the aforementioned rapping mold 70 are not limited, if the rapping mold is formed so as to conform to the forming pattern of the optical film 51.

Next, as shown in FIG. 6C, the sections of the substrate base material 50 where the optical film 51 is unnecessary are peeled away from the holding material 54 (Step 3). At this time, the adhesive layer 52 in the sections where the optical film 51 is unnecessary is also peeled away.

A substrate comprising glass, ceramic, resin, or the like, is cut to obtain a disk-like substrate base material 30 having a narrower diameter than the outer diameter of the wafer ring 20 (Step 4). An adhesive layer 41 is provided over the entire top face of the holding material 40, which has a larger diameter than the substrate base material 30, and the peripheral section of the holding material 40 is pasted to the bottom face of an wafer ring 20 (Step 5). Then, as shown in FIG. 6D, the substrate base material 30 is pasted on the holding material 40 in the region inside the wafer ring 20, with the adhesive layer 41 therebetween (Step 6). Then, as shown in FIG. 6E, the substrate base material 30 is cut (diced) into a grid-like shape in plan view by using an unillustrated blade, thereby dividing it into a plurality of substrates 31 (Step 7).

Next, as shown in FIG. 7A, the structure made in Step 3 (see FIG. 6C) is affixed to the structure made in Step 7 (see FIG. 6E). The optical films 51 on the holding material 54 and the substrates 31 on the adhesive layer 41 are pasted together with the adhesive layer 52 therebetween. As a result, a plurality of optical elements 60 are obtained. Finally, as shown in FIG. 7B, the holding material 54 and the adhesive layer 53 are peeled away, to complete the optical element wafer 10 of this embodiment.

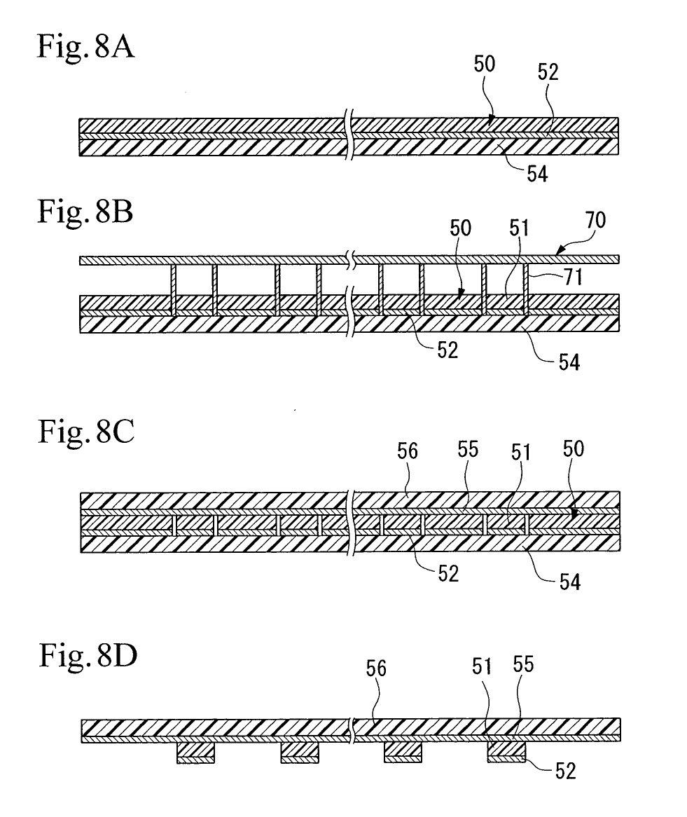

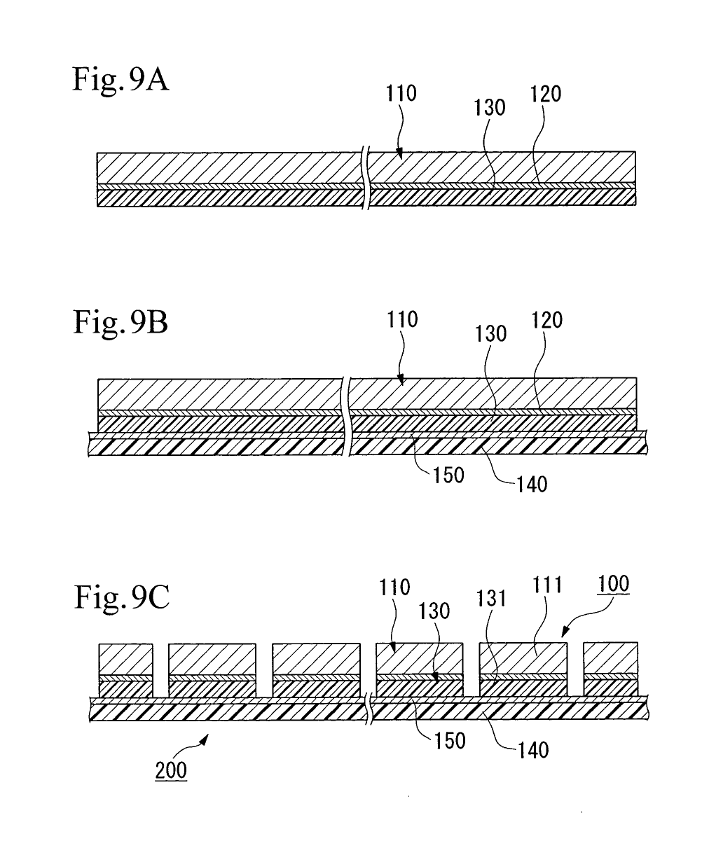

Subsequently, another example of the manufacturing method of the optical element wafer will be explained with reference to FIGS. 8A to 8D.

Firstly, as shown in FIG. 8A, the holding material 54 comprising a resin film such as polyethylene terephthalate is pasted over one face of the substrate base material 50 with the adhesive layer 53 therebetween. This process differs from that of the previous example in that another adhesive layer is not provided on the other face of the substrate base material 50.

Next, as shown in FIG. 8B, the substrate base material 50 is rapped by using a rapping mold 70, dividing it into a plurality of optical films 51 in the same manner as in the previous example.

As shown in FIG. 8C, another holding material 56 comprises a resin film such as polyolefin film, and is pasted onto the opposite side of the substrate base material 50 to the holding material 54 with an adhesive layer therebetween.

Then, as shown in FIG. 8D, the holding material 54 which was pasted first, and the section of the substrate base material 50 where the optical film 51 is unnecessary, are peeled away from the holding material 56 which was pasted subsequently. In this way, the same structure as that shown in FIG. 6C is obtained, and thereafter, the optical element wafer 10 can be manufactured in the same manner as in the previous example.

The optical element 60 can be manufactured after the optical element wafer 10 has been manufactured by the processes described above, by picking up and extracting a desired optical element 60 from the holding material 40 side.

The manufacturing methods of the optical element wafer 10 and the optical element 60 described above are performed using the same optical film base material as in conventional methods. However, after the substrate base material 50 has been affixed to the holding material 54 and divided into a plurality of optical films having smaller areas than the substrates 31, and the sections where the optical films 51 is unnecessary have been removed, the optical films 51 are pasted to the substrate base material 30.

Therefore, in the substrate base material 50, sections where the optical film 51 is unnecessary and can be reused. That is, in the second and subsequent manufacturing operations, the optical films 51 can be obtained from the remaining sections of the substrate base material 50, making it possible to produce the optical films 51 of a plurality of optical element wafers 10 from a single optical film base material 50. This noticeably reduces the amount of optical film base material 50 which is used, consequently reducing the cost of the optical element wafer 10 and the optical element 60.

The substrate base material 50 and the substrate base material 30 are pasted on different holding materials 54 and 40, and are cut separately into a plurality of optical films 51 and substrates 31, before affixing them together; therefore, at the time of cutting the substrate base material 30, irrespective of the material comprising the substrate base material 30, there is no need to reduce the cutting speed to match that of the substrate base material 50, thereby noticeably shortening the cutting process of the substrate base material 30.

Since the substrate base material 50 is rapped by a rapping mold 70 having a plurality of cylindrical protrusions 71 in correspondence with the pattern of the substrate base material 50, a plurality of the optical films 51 can be created in a single operation.

Since the substrate base material 50 and the substrate base material 30 are cut separately, there is no variation in the abrasion of the blade when cutting the substrate base material 30, enabling the cutting depth to be stably controlled. Furthermore, since the substrate base material 50 is cut by using the rapping mold 70, the cutting depth can be easily controlled.

Each of the small-area optical films 51 and substrates 31 can be easily and evenly pasted together without air becoming trapped therebetween. Therefore, there is no danger that the optical films 51 will peel away due to the expansion of air trapped between the optical films 51 and the substrates 31 after the electronic components have been manufactured.

The manufacturing methods of the optical element wafer and the optical element of this invention are not limited to the embodiment described above.

For example, the substrate base material 30 can be divided into the plurality of substrates 31 prior to dividing the substrate base material 50 into the plurality of optical films 51.

After dividing the substrate base material 50 into the plurality of optical films 51 and removing the sections where the optical films 51 is unnecessary, the remaining optical films 51 may be pasted to the substrate base material 30, which is thereafter divided into a plurality of substrates 31 having larger areas than the optical films 51, to obtain the plurality of optical elements 60.

In the embodiment described above, the substrate base material 30 was disk-shaped, but it may be another shape, e.g. square.

As described in detail above, according to this invention, it is possible to obtain the optical element which is inexpensive and prevents the optical film from partially peeling away and rising up at the time of pasting it to the main body of a package, the optical element wafer which can manufacture, store, and carry a plurality of the optical elements in a single operation, and manufacturing methods thereof.

Further, the manufacturing method of the optical element wafer according to this invention shortens the cutting process of the substrate base material, and in addition, stably controls the cutting depth of the substrate base material and the substrate base material, and enables them to be evenly affixed together.

1. An optical element comprising a substrate and an optical film, which is partially pasted to a substrate.

2. The optical element according to claim 1, wherein the substrate is obtained by cutting a substrate base material.

3. The optical element according to claim 1, wherein the substrate is obtained by dicing a substrate base material.

4. An optical element wafer comprising a substrate base material and a holding material, one surface of which is pasted on the substrate base material, wherein, in optical element wafer having a plurality of substrates formed by dividing the substrate base material into a plurality of substrates, an optical film is partially pasted to each substrate.

5. The optical element wafer according to claim 4, wherein the optical film is a phase difference film.

6. The optical element wafer according to claim 4, further comprising an adhesive layer, provided in a connecting portion of each substrate, which connects each optical element to a main body of a package.

7. A method for manufacturing an optical element comprising the steps of:
dividing a base material of an optical film into a plurality of optical films;
removing sections of the optical film base material where the optical film is unnecessary;
dividing a substrate base material into a plurality of substrates;
pasting each optical film on each substrate to thereby form a plurality of optical elements; and
separating optical element.

8. A method for manufacturing the optical element comprising the steps of:
dividing an optical film base material into a plurality of optical films;
removing sections of the optical film base material where the optical film is unnecessary;
pasting the optical films to a substrate base material;
dividing the substrate base material into a plurality of substrates, thereby obtaining a plurality of optical elements; and
separating optical elements.

9. A method for manufacturing the optical element wafer comprising the steps of:
dividing a optical film base material into a plurality of optical films;
removing sections of the optical film base material where the optical film is unnecessary;
dividing a substrate base material into a plurality of substrates; and
pasting each optical film on each substrate.

10. A method for manufacturing the optical element wafer comprising the steps of:
pasting the optical film base material on a first holding material;
dividing the optical film base material into a plurality of optical films;
peeling away from the first holding material sections of the optical film base material where the optical film is unnecessary;
pasting a substrate base material on a second holding material;
dividing the substrate base material into a plurality of substrates; and
pasting the optical film on the first holding material onto the substrates on the second holding material.

11. A method for manufacturing the optical element wafer comprising the steps of:
pasting a optical film base material onto the first holding material;
dividing the optical film base material into a plurality of optical films;
pasting a second holding material onto one side of the substrate base material which is opposite to the first holding material;
peeling away from the first holding material sections of the optical film base material where the optical film is unnecessary;
pasting a substrate base material onto a third holding material;
dividing the substrate base material into a plurality of substrates; and
pasting together the optical films on the second holding material with the substrates on the third holding material.

12. A method for manufacturing the optical element wafer comprising the steps of:
dividing the optical film base material into a plurality of optical films;
removing sections of the optical film base material where the optical film is unnecessary;
pasting the optical films to a substrate base material; and
dividing the substrate base material into a plurality of substrates, thereby obtaining a plurality of optical elements.

13. The method for manufacturing the optical element wafer according to claim 9, wherein the step of dividing the substrate base material into a plurality of optical films comprises:
rapping the optical film base material by using a rapping mold formed for dividing the optical film into a required pattern in patterning the optical film base material.

14. The method for manufacturing the optical element wafer according to claim 10, wherein the step of dividing the substrate base material into a plurality of optical films comprises:
rapping the optical film base material by using a rapping mold formed for dividing the optical film into a required pattern in patterning the optical film base material.

15. The method for manufacturing the optical element wafer according to claim 11, wherein the step of dividing the substrate base material into a plurality of optical films comprises:
rapping the optical film base material by using a rapping mold formed for dividing the optical film into a required pattern in patterning the optical film base material.

16. The method for manufacturing the optical element wafer according to claim 12, wherein the step of dividing the substrate base material into a plurality of optical films comprises:
rapping the optical film base material by using a rapping mold formed for dividing the optical film into a required pattern in patterning the optical film base material.

17. The optical element wafer according to claim 5, further comprising an adhesive layer, provided in a connecting portion of each substrate, which connects each optical element to a main body of a package.
